(19) United States
(12) Patent Application Publication
(10) Pub. No.: US 2020/0065777 A1
(43) Pub. Date: Feb. 27, 2020

(54) EQUIPMENT SERVICE ANALYTICS AND SERVICE AUCTION MARKETPLACE

(71) Applicant: CARRIER CORPORATION, Palm Beach Gardens, FL (US)

(72) Inventors: Tony Spath, West Hartford, CT (US); Craig Drew Bogli, Avon, CT (US); Tadeusz Pawel Witczak, Farmington, CT (US); Yrinee Michaelidis, Farmington, CT (US)

(21) Appl. No.: 16/546,353

(22) Filed: Aug. 21, 2019

Related U.S. Application Data
(60) Provisional application No. 62/720,562, filed on Aug. 21, 2018.

(51) Int. Cl. G06Q 10/00; H04L 9/06; G06Q 30/08

(52) U.S. Cl. CPC G06Q 10/20; G06Q 30/08; H04L 9/0637

(57) ABSTRACT

Methods and systems for equipment service analytics are provided. Aspects include receiving, by a processor, equipment data associated with equipment located at a site. Obtaining historical data associated with the equipment and analyzing the equipment data and historical data to determine an action for the equipment, wherein the determining the action for the equipment comprises generating a cost model based at least in part on the equipment data and the historical data and estimating a repair cost and a replacement cost for the equipment based at least in part on the cost model.

### CROSS-REFERENCE TO RELATED APPLICATIONS

This application claims the benefit of U.S. Provisional Application No. 62/720,562, filed Aug. 21, 2018, which is incorporated herein by reference in its entirety.

### BACKGROUND

Exemplary embodiments pertain to the art of maintenance and service of equipment and more specifically to equipment service analytics and service auction marketplace.

When building owners, facility managers and service technicians are faced with the choice between repair and replacement of equipment they are challenged by lack of adequate knowledge of the maintenance history and cost to replace a unit. This can make it very difficult for facility managers and service technicians to make an informed decision regarding the replacement or repair of equipment. Also, this lack of knowledge can potentially reduce the number of new equipment sales.

### BRIEF DESCRIPTION

According to one embodiment, a computer-implemented method is provided. The method includes receiving, by a processor, equipment data associated with equipment located at a site. Obtaining historical data associated with the equipment and analyzing the equipment data and historical data to determine an action for the equipment, wherein the determining the action for the equipment comprises generating a cost model based at least in part on the equipment data and the historical data and estimating a repair cost and a replacement cost for the equipment based at least in part on the cost model.

In addition to one or more of the features described above, or as an alternative, further embodiments of the method may include that the action includes a replacement recommendation for the equipment.

In addition to one or more of the features described above, or as an alternative, further embodiments of the method may include that the historical data includes a maintenance history associated with the equipment.

In addition to one or more of the features described above, or as an alternative, further embodiments of the method may include that the historical data includes environmental data associated with the equipment.

In addition to one or more of the features described above, or as an alternative, further embodiments of the method may include that the equipment data is collected by a sensor associated with the equipment.

In addition to one or more of the features described above, or as an alternative, further embodiments of the method may include that the sensor is an IoT device.

In addition to one or more of the features described above, or as an alternative, further embodiments of the method may include that the action includes a repair recommendation for the equipment.

In addition to one or more of the features described above, or as an alternative, further embodiments of the method may include transmitting, to an auction marketplace, the repair recommendation, wherein the repair recommendation includes a repair rating and a repair description. Receiving one or more bids for the repair recommendation, wherein the one or more bids includes a price for repair and a service personnel rating and analyzing the one or more bids to determine a winning bid based on the price for repair and the service personnel rating.

In addition to one or more of the features described above, or as an alternative, further embodiments of the method may include that the auction marketplace is a distributed database that includes a plurality of data records, the data records include equipment repair bids associated with a plurality of equipment.

In addition to one or more of the features described above, or as an alternative, further embodiments of the method may include that the distributed database is block chain that receives data for storage, the data received for storage is configured to be processed to generate a transaction record that is dependent on previous data stored in the block chain.

In addition to one or more of the features described above, or as an alternative, further embodiments of the method may include transmitting a token to a service person associated with the winning bid and transmitting the token to an IoT device, wherein the token authenticates the service person and wherein the IoT device provides access to the equipment.

In addition to one or more of the features described above, or as an alternative, further embodiments of the method may include that receiving, from a service person associated with the winning bid, a repair confirmation and storing the repair confirmation in the transaction record.

In addition to one or more of the features described above, or as an alternative, further embodiments of the method may include that the repair confirmation includes an image of the equipment.

According to one embodiment, a system is provided. The system includes a processor communicatively coupled to a server, the processor operable to: receive equipment data associated with equipment located at a site; obtain historical data associated with the equipment and analyze the equipment data and historical data to determine an action for the equipment. The determining the action for the equipment includes generating a cost model based at least in part on the equipment data and the historical data and estimating a repair cost and a replacement cost for the equipment based at least in part on the cost model.

In addition to one or more of the features described above, or as an alternative, further embodiments of the system may include that the action includes a repair recommendation for the equipment.

In addition to one or more of the features described above, or as an alternative, further embodiments of the system may include that the processor is further configured to transmit, to an auction marketplace, the repair recommendation, wherein the repair recommendation includes a repair rating and a repair description. Receive one or more bids for the repair recommendation, wherein the one or more bids include a price for repair and a service personnel rating and analyze the one or more bids to determine a winning bid based on the price for repair and the service personnel rating.

In addition to one or more of the features described above, or as an alternative, further embodiments of the system may include that the auction marketplace is a distributed database that includes a plurality of data records, the data records include equipment repair bids associated with a plurality of equipment and wherein the distributed database is block chain that receives data for storage, the data received for storage is configured to be processed to generate a transaction record that is dependent on previous data stored in the block chain.

In addition to one or more of the features described above, or as an alternative, further embodiments of the system may include that the processor is further configured to transmit a token to a service person associated with the winning bid and transmit the token to an IoT device, wherein the token authenticates the service person, wherein the IoT device provides access to the equipment.

In addition to one or more of the features described above, or as an alternative, further embodiments of the system may include that the historical data includes a maintenance history associated with the equipment.

In addition to one or more of the features described above, or as an alternative, further embodiments of the system may include that the historical data includes environmental data associated with the equipment.

### BRIEF DESCRIPTION OF THE DRAWINGS

The following descriptions should not be considered limiting in any way. With reference to the accompanying drawings, like elements are numbered alike:

FIG. 1 depicts a block diagram of a computer system for use in implementing one or more embodiments;

FIG. 2 depicts a diagram of a system for equipment service analytics and service auction marketplace according to embodiments; and

FIG. 3 depicts a flow chart of a method for equipment service analytics according to one or more embodiments.

The diagrams depicted herein are illustrative. There can be many variations to the diagram or the operations described therein without departing from the spirit of the disclosure. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

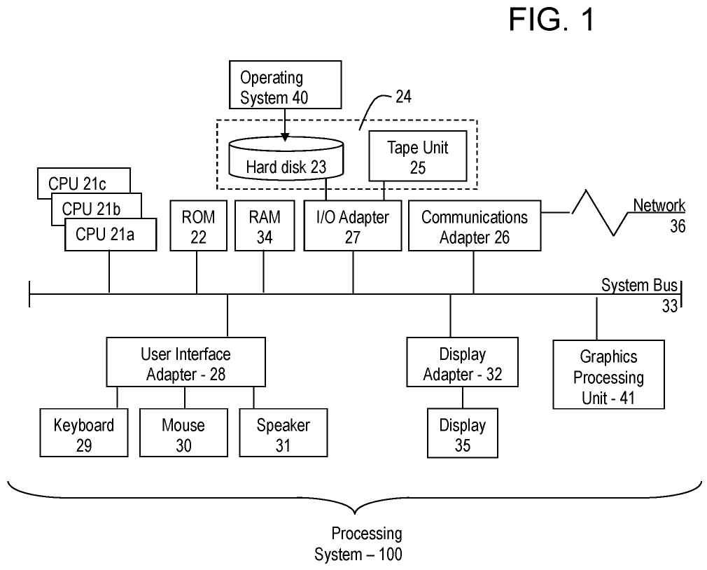

Referring to FIG. 1, there is shown an embodiment of a processing system 100 for implementing the teachings herein. In this embodiment, the system 100 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 100.

FIG. 1 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 100 may be stored in mass storage 24. The network adapter 26 interconnects bus 33 with an outside network 36 enabling data processing system 100 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 are all interconnected to bus 33 via user interface adapter 28, which may include, for example, a Super I/O chip integrating multiple device adapters into a single integrated circuit.

In exemplary embodiments, the processing system 100 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 1, the system 100 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system to coordinate the functions of the various components shown in FIG. 1. The processing system 100 described herein is merely exemplary and not intended to limit the application, uses, and/or technical scope of the present disclosure, which can be embodied in various forms known in the art.

Turning now to an overview of technologies that are more specifically relevant to aspects of the disclosure, site owners often must make decisions between repairing and replacing a piece of equipment at the site. In this case, a site can be an office building, manufacturing facility, or the like. In the heating, ventilation, and air conditioning (HVAC) space, the decision between repairing or replacing a roof top unit can be a costly decision. Some factors that would influence the decision between repair and replace include adequate knowledge of the maintenance history and cost to replace the roof top unit. In addition, when the decision to repair the roof top unit is made, it can be difficult to identify capable labor to perform the repair work on the roof top unit and also to negotiate a competitive rate. There exists a need for an analytical system that would allow a site owner to view forecasted cost for replacement HVAC equipment and an estimated cost for repairing the HVAC equipment. In addition, should an HVAC equipment repair decision be made, there exists a need for an auction marketplace for service personnel and site owners.

Turning now to an overview of the aspects of the disclosure, one or more embodiments address the above-described shortcomings of the prior art by providing a system for repair versus replace decision making analytics for HVAC equipment and an auction marketplace for service personnel to submit bids for repair work on the HVAC equipment. The system allows for a site owner to view a forecasted cost for replacement of equipment or the cost to repair equipment. These costs can be generated based on information from a host of sources. Some of the sources of the information can include algorithms that analyze past or historical work performed on other equipment in the same region as the equipment in question. This information can be submitted by service personnel that have performed similar work in the same region as the equipment and site owner. Current and declining health metrics of the equipment can be obtained from sensors (e.g., Internet of Things (IoT) devices) on or near the equipment. These sensors can determine the health of the equipment which includes age, operational data, environmental data, and the like. This sensor data can be transmitted to a cloud server that analyzes the sensor data to determine whether a repair is needed and also determine the cost of the repair. The cloud server can provide a comparison cost between the replacement of the equipment versus the repair of the equipment based on a parts database and historical labor costs for specific types of repairs. The repair costs could be supplied by local service technicians that may be bidding on equipment repair business in an auction marketplace. The replacement costs can be supplied by original equipment manufacturers and/or local service contractors, collected historical data, and sensor data. In addition, the maintenance history can be tracked using the sensor on the equipment and stored locally in the sensor or stored in the cloud.

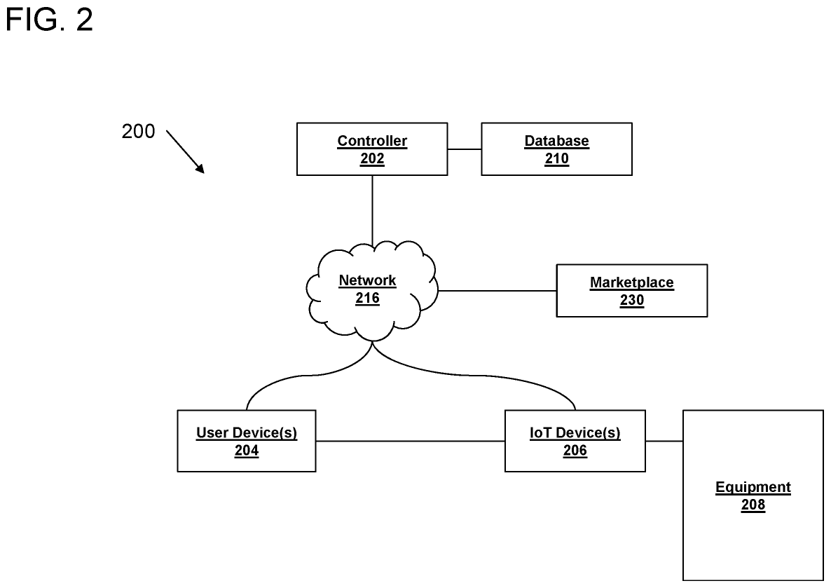

Turning now to a more detailed description of aspects of the present disclosure, FIG. 2 depicts a diagram of a system for equipment service analytics and a service auction marketplace according to one or more embodiments. The system 200 includes a controller 202, a user device 204, an IoT device 206, equipment 208, a database 210, a network 216, and a marketplace 230.

In one or more embodiments, the controller 202, user device 204, and IoT device 206 can be implemented on the processing system 100 found in FIG. 1. Additionally, the network 216 can be utilized for electronic communication between and among the controller and other devices. The network 216 can be in wired or wireless electronic communication with one or all of the elements of the system 200. Cloud computing can supplement, support or replace some or all of the functionality of the elements of the system 200. Additionally, some or all of the functionality of the elements of system 200 can be implemented as a cloud computing node. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

In one or more embodiments, the system 200 provides equipment service analytics through collection of sensor data through an IoT device 206 (or IoT devices). The IoT device 206 can be any type of sensor configured to collect equipment data related to the equipment. For example, a sensor can be attached to a rooftop HVAC unit and collect operational and performance data on the rooftop unit. The IoT device 206 can transmit the sensor data through the network 216 for analytics related to the operation and performance of the rooftop unit. In one or more embodiments, the analytics can be performed in the cloud network 216 or can be performed on a user device 204. The user device 204 can be a smart device utilized by a service technician and the IoT device 206 can transmit the sensor data related to the equipment 208 to the user device 204 for analytics of the operational and performance data. The user device 204 can also communicate to the cloud network 216 to access equipment information stored in the database 210. In one or more embodiments, the database 210 can be an OEM database including parts data, equipment data, and historical information such as maintenance records and repair logs.

The term Internet of Things (IoT) device is used herein to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet.

In one or more embodiments, the network 216 and controller 202 can analyze the sensor data received from the IoT device 206 to determine an action to be performed on the equipment 208. Actions include performing maintenance on the equipment, performing a repair of the equipment, or performing a replacement of the equipment 208. The action to be taken can be determined on the sensor data received from the IoT device 206 for the equipment 208 along with historical maintenance and repair data on the equipment 208. Historical data can include the service life of parts within the equipment 208. For example, a compressor for an HVAC system can have an expected service life of a number of years and the historical data can indicate when the compressor was placed in to service. In addition, service life can be extended through regular maintenance or scheduled repairs. The extended service life can be included in the historical data to predict a need for additional maintenance, repairs, and/or replacement of the compressor or other parts in the equipment 208. Utilizing historical data and the sensor data for the equipment, the system 200 can predict the need for maintenance, repair, or replacement of parts and/or an entire piece of equipment 208. Based on this prediction, a site owner can anticipate forecasted costs for the equipment 208 on site.

In one or more embodiments, once an action for the equipment 208 has been established by the system 200, the system 200 can perform a cost analysis for the repair costs and the replacement costs for the equipment 208. The cost analysis can include building a cost model which includes the repair costs, the replacement costs, the expected service life of the repaired equipment, and the expected service life of new/refurbished equipment as variables in the cost model. In addition, the service life can be adjusted based on historical data that includes environmental data associated with the location of the equipment. For example, for HVAC systems in hot, dry environments, the outside equipment (e.g., rooftop units) may have reduced service life. In another example, HVAC systems in salty environments, such as in locations near the ocean, may have different services lives than locations in cooler locations. In one or more embodiments, the cost model can determine the cost benefit analysis of replacing the equipment versus repairing the equipment and present the cost benefit to the site owner. In one or more embodiments, the cost model can utilize algorithms, such as profit algorithms, for determining the cost benefit between repairing equipment and replacing equipment.

In one or more embodiments, the system 200 can send out a repair recommendation to the marketplace 230 to receive bids from service technicians. In one or more embodiments, the equipment 208 can be continuously monitored by the IoT device 206 to determine fault detection and identification from sensor data collected on the equipment. This fault detection data can be transmitted through the network 216 to the marketplace 230 whereby service technicians can bid or submit costs estimates related to the fault detection data. For example, if the equipment 208 is in need of a repair due to some detected issue, the repair data can be forwarded to the marketplace 230 to begin the bidding process for service technicians. The fault data can be transmitted to the site owner of the equipment along with a number of bids from the marketplace 230 to allow for the site owner to accept a bid or reject a bid and present counter-offers to the bid. The fault data and bids can also be compared to the estimated cost of replacement of the equipment 208 for the site owner to make a decision regarding the equipment. In one or more embodiments, the service technicians can be authenticated through the marketplace 230 as qualified laborers based on a number of factors including, but not limited to, certifications, work history, and the like. The site owner can review the bids along with the service technician information to make a determination on accepting or rejecting proposed bids. The transactions on the marketplace 230 can be authenticated utilizing a block chain like authentication to assure that a repair bid has been accepted, the repair has occurred, and the equipment 208 is operating properly after the repair is complete. Once authenticated, payment can be triggered by the marketplace 230 to complete the transaction and to store the completed transaction in a transaction history stored in a distributed database (i.e., the block chain).

In one or more embodiments, the marketplace 230 is a distributed database such as a block chain. A block chain is a decentralized, distributed and public digital ledger that is used to record transactions across many computers so that the record cannot be altered retroactively without the alteration of all subsequent blocks and the collusion of the network. This allows the participants to verify and audit transactions inexpensively. A block chain database is managed autonomously using a peer-to-peer network and a distributed timestamping server. They are authenticated by mass collaboration powered by collective self-interests (e.g., site owners, service technicians, OEMs, etc.).

The block chain structure enables users' access to securely store data in a public place. The data is deemed secure, as each time data is written, the written data is dependent on previously written data, which includes performing cryptographic hash operations. A benefit of using a block chain is that once data is written to the block chain and a block chain transaction is created, that transaction remains intact, and can be verified in the future. The reason for this, is that data is continually written to the block chain, e.g., after a particular transaction is made, and that later data is dependent on an earlier particular transaction. Consequently, by writing data to a public storage facility that implements a public block chain, later verification of that data is practically ensured to be correct.

The block chain can ensure the integrity of transaction information. For a public block chain, the entities that are posting to the blockchain can be virtually anyone. Therefore identification and authentication of the entity that posted a transaction to the blockchain is important. Identification and authentication can be done by including identifiers in the blockchain record that indicate who created the record, who provided which part of the record. (i.e., if someone places a bid in the auction market place 230, who submitted the bid?, if someone accepts the bid?, who is the service technician?). Systems that then consume the block chain record would indicate whether additional transactions were done on top. For example, was the payment remitted? Are access rights being granted? Is the bid accepted/rejected? The IoT device 206 or controller 202 can review all of these transaction inputs and verify the identities before allowing access to the equipment 208. Verifying identities can include verifying digital signatures that are contained inside of a transaction record that are separate from the actual block-chain mechanism that ensures a transaction record on the chain is kept intact and is verified as being intact.

In one or more embodiments, access to the blockchain may be limited to specific controllers—in this sense it is a public blockchain but only public to a limited set of controllers who are allowed to record to the blockchain. The controllers are managed by entities owning the equipment who know each other and can identify each other by their respective controllers. The controllers record transactions using digital signatures to provide verifiability that a particular controller did indeed create a transaction. An IoT device may be pre-configured to only send out accept authorized transactions from a particular controller that they are associated with so that the IoT device has a public key for the controller and can verify the controller's digital signatures made with the controller's private key. This way the IoT device only needs to know one public key.

In one or more embodiments, authentication methods can include providing a hash of an authentication input. The hash is stored with the transaction. The IoT device 206 will perform the hash on a second input provided from the user device 204 to the IoT device 206. If the resulting hash matches the hash stored in the transaction then the customer is deemed to be authentic. The input could be a password, a PIN, an identity, etc. that is controlled by the user of the user device 204 so that they are the only ones that can prove their identity. Since the public block chain is public anyone can see the “hash” but they cannot reverse back to find the actual input for creating the hash.

Internet of things (IoT) devices 206 associated with the equipment 208 can also include devices that provide access to a service technician looking to perform maintenance or repairs on the equipment 208. For example, an electronic lock can communicate with the cloud network 216 to verify a service technician should have access to the equipment 208 and for how long. Once the service technician's identity if verified, the electronic lock can be unlocked remotely allowing access to the equipment room. Or an electronic lock can be unlocked by the service technician using a token or key downloaded on to their user device 204. Additional authentication can include a hash, a password, a PIN, an identity, etc. that is controlled by the service technician's user device 204 so that they are the only ones that can prove their identity.

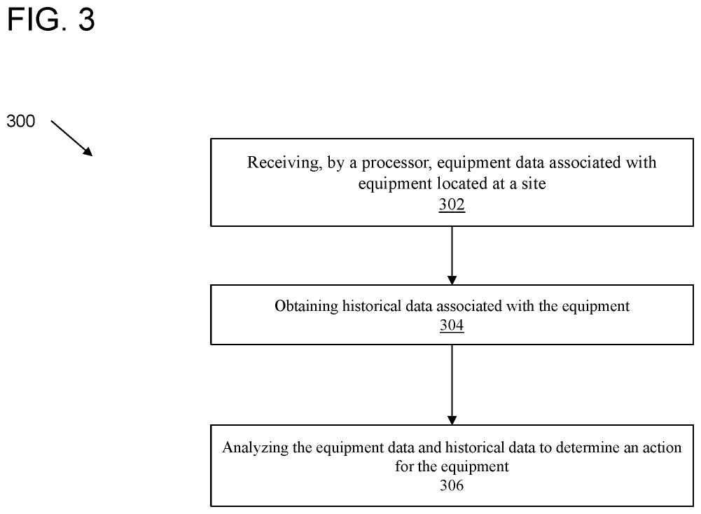

FIG. 3 depicts a flow chart of a method for equipment service analytics according to one or more embodiments. The method 300 includes receiving, by a processor, equipment data associated with equipment located at a site, as shown in block 302. The method 300, at block 304, includes obtaining historical data associated with the equipment. And at block 306, the method 300 includes analyzing the equipment data and historical data to determine an action for the equipment, wherein the determining the action for the equipment comprises generating a cost model based at least in part on the equipment data and the historical data and estimating a repair cost and a replacement cost for the equipment based at least in part on the cost model.

Additional processes may also be included. It should be understood that the processes depicted in FIG. 3 represent illustrations, and that other processes may be added or existing processes may be removed, modified, or rearranged without departing from the scope and spirit of the present disclosure.

A detailed description of one or more embodiments of the disclosed apparatus are presented herein by way of exemplification and not limitation with reference to the Figures.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A computer-implemented method for equipment service analytics, the method comprising:
receiving, by a processor, equipment data associated with equipment located at a site;
obtaining historical data associated with the equipment; and
analyzing the equipment data and historical data to determine an action for the equipment, wherein the determining the action for the equipment comprises:
generating a cost model based at least in part on the equipment data and the historical data; and
estimating a repair cost and a replacement cost for the equipment based at least in part on the cost model.

2. The computer-implemented method of claim 1, wherein the action comprises a replace recommendation for the equipment.

3. The computer-implemented method of claim 1, wherein the historical data comprises a maintenance history associated with the equipment.

4. The computer-implemented method of claim 1, wherein the historical data comprises environmental data associated with the equipment.

5. The computer-implemented method of claim 1, wherein the equipment data is collected by a sensor associated with the equipment.

6. The computer-implemented method of claim 5, wherein the sensor is an IoT device.

7. The computer-implemented method of claim 1, wherein the action comprises a repair recommendation for the equipment.

8. The computer-implemented method of claim 7, further comprising:
transmitting, to an auction marketplace, the repair recommendation, wherein the repair recommendation comprises a repair rating and a repair description;
receiving one or more bids for the repair recommendation, wherein the one or more bids comprise a price for repair and a service personnel rating; and
analyzing the one or more bids to determine a winning bid based on the price for repair and the service personnel rating.

9. The computer-implemented method of claim 8, wherein the auction marketplace is a distributed database that includes a plurality of data records, the data records comprise equipment repair bids associated with a plurality of equipment.

10. The computer-implemented method of claim 9, wherein the distributed database is block chain that receives data for storage, the data received for storage is configured to be processed to generate a transaction record that is dependent on previous data stored in the block chain.

11. The computer-implemented method of claim 8, further comprising:
transmitting a token to a service person associated with the winning bid; and
transmitting the token to an IoT device, wherein the token authenticates the service person; and
wherein the IoT device provides access to the equipment.

12. The computer-implemented method of claim 10, further comprising:
receiving, from a service person associated with the winning bid, a repair confirmation; and
storing the repair confirmation in the transaction record.

13. The computer-implemented method of claim 12, wherein the repair confirmation comprises an image of the equipment.

14. A system for equipment service analytics, the system comprising:
a processor communicatively coupled to a server, the processor operable to:
receive equipment data associated with equipment located at a site;
obtain historical data associated with the equipment; and
analyze the equipment data and historical data to determine an action for the equipment, wherein the determining the action for the equipment comprises:
generating a cost model based at least in part on the equipment data and the historical data; and
estimating a repair cost and a replacement cost for the equipment based at least in part on the cost model.

15. The system of claim 14, wherein the action comprises a repair recommendation for the equipment.

16. The system of claim 15, wherein the processor is further configured to:
transmit, to an auction marketplace, the repair recommendation, wherein the repair recommendation comprises a repair rating and a repair description;
receive one or more bids for the repair recommendation, wherein the one or more bids comprise a price for repair and a service personnel rating; and
analyze the one or more bids to determine a winning bid based on the price for repair and the service personnel rating.

17. The system of claim 15, wherein the auction marketplace is a distributed database that includes a plurality of data records, the data records comprise equipment repair bids associated with a plurality of equipment; and
wherein the distributed database is block chain that receives data for storage, the data received for storage is configured to be processed to generate a transaction record that is dependent on previous data stored in the block chain.

18. The system of claim 15, wherein the processor is further configured to:
transmit a token to a service person associated with the winning bid; and
transmit the token to an IoT device, wherein the token authenticates the service person; and
wherein the IoT device provides access to the equipment.

19. The system of claim 14, wherein the historical data comprises a maintenance history associated with the equipment.

20. The system of claim 14, wherein the historical data comprises environmental data associated with the equipment.
